(19) United States
(12) Patent Application Publication
(10) Pub. No.: US 2020/0160552 A1
(43) Pub. Date: May 21, 2020

(54) OBJECT DETECTION DEVICE, OBJECT DETECTION METHOD, AND COMPUTER PROGRAM FOR DETECTING OBJECT

(71) Applicant: TOYOTA JIDOSHA KABUSHIKI KAISHA, Toyota-shi (JP)

(72) Inventors: Daisuke HASHIMOTO, Chofu-shi (JP); Satoshi TAKEYASU, Musashino-shi (JP); Kota HIRANO, Edogawa-ku (JP)

(73) Assignee: TOYOTA JIDOSHA KABUSHIKI KAISHA, Toyota-shi (JP)

(21) Appl. No.: 16/671,819

(22) Filed: Nov. 1, 2019

(30) Foreign Application Priority Data
Nov. 15, 2018 (JP) 2018-215061

(51) Int. Cl. G06T 7/70; G06K 9/00; G06T 7/62

(52) U.S. Cl. CPC G06T 7/70; G06K 9/209; G06T 7/62; G06K 9/00791

(57) ABSTRACT

An object detection device is configured to: detect from an acquired image whether a predetermined part of an outer shape of an object in question shown in that image is hidden by another object shown in that image; and detect a position and/or size of the object in question based on a position of the part of the outer shape of the object in question hidden by the other object, when it is detected that the predetermined part of the outer shape of the object in question is hidden.

### FIELD

The present invention relates to an object detection device, object detection method, and computer program for detecting object.

### BACKGROUND

Known in the past has been the art of detecting an object shown in an image generated by a camera, etc. In recent years, the art of using a neural network to detect an object and thereby improve the precision of detection of the object has been proposed (for example, NPL 1).

### CITATIONS LIST

### Non Patent Literature

[NPL 1] Wei Liu et al., “SSD: Single Shot MultiBox Detector”, ECCV2016, 2016

### SUMMARY

### Technical Problem

In this regard, if using the above-mentioned object detection technique, it is possible to detect the position of an object with respect to the camera or the size of the object, based on the image size of the detected object, etc. Therefore, for example, it is possible to detect the position of an object (for example, another vehicle) with respect to the vehicle or the size of that object in the image, based on the image size, etc., of the object shown in the image generated by the camera mounted in the vehicle.

In this regard, however, in an image generated by a camera, etc., objects are not always positioned separated from each other. Some objects are often partially hidden by other objects. If part of an object is hidden in this way, the image size of the object is smaller compared with the case where the object as a whole is shown in the image. Therefore, in this case, if detecting the position of an object with respect to a vehicle or the size of that object, etc., based on the image size, the position or size of the object will be mistakenly recognized.

The present invention was made in consideration of the above problem and has as its object to keep the position and size of an object in question shown in an image from being mistakenly recognized.

### Solution to Problem

The present invention was made so as to solve the above problem and has as its gist the following.

(1) An object detection device, comprising: a first detecting part detecting from an acquired image whether a predetermined part of an outer shape of an object in question shown in that image is hidden by another object shown in that image; and a second detecting part detecting a position and/or size of the object in question based on a position of the part of the outer shape of the object in question hidden by the other object, when it is detected that the predetermined part of the outer shape of the object in question is hidden.

(2) The object detection device according to above (1), wherein the second detecting part estimates the outer shape of the object in question when assuming that the object in question as a whole is not hidden, based on the position of the hidden part, and detects the position and/or size of the object in question based on that estimated outer shape.

(3) The object detection device according to above (2) wherein the second detecting part estimates the outer shape of the object in question at a time assuming that the object in question as a whole is not hidden, based on the position of the hidden part, by using a past image which was acquired before that image and in which the outer shape of the object in question was not hidden by another object.

(4) The object detection device according to any one of above (1) to (3), wherein when dividing the outer lines of a shape circumscribing the object in question shown in the image into a plurality of portions, the first detecting part judges that the predetermined part of the outer shape of the object in question is hidden by another object shown in the image, if one divided portion as a whole is positioned inside a shape circumscribing the other object or on the outer lines of that shape.

(5) The object detection device according to any one of above (1) to (4), wherein the first detecting part inputs the image in a neural network which is learned in advance so as to output whether the predetermined part of the outer shape of the object in question is hidden by another object shown in the image when the image is input, and thereby detects if the predetermined part of the outer shape of the object in question is hidden by another object.

(6) An object detection method, comprising: detecting, from an acquired image, whether a predetermined part of an outer shape of an object in question shown in that image is hidden by another object shown in that image; and detecting a position and/or size of the object in question based on a position of the part of the outer shape of the object in question hidden by the other object when it is detected that the predetermined part of the outer shape of the object in question is hidden.

(7) A computer program for detecting object, making a computer: detect, from an acquired image, whether a predetermined part of an outer shape of an object in question shown in that image is hidden by another object shown in that image; and detect a position and/or size of the object in question, based on a position of the part of the outer shape of the object in question hidden by the other object, when it is detected that the predetermined part of the outer shape of the object in question is hidden.

### Advantageous Effects of Invention

According to the present invention, the position and size of an object in question shown in an image is kept from being mistakenly recognized.

### BRIEF DESCRIPTION OF DRAWINGS

FIG. 1 is a view schematically showing the constitution of a vehicle control system according to an embodiment is mounted.

FIG. 2 is a view of a hardware configuration of an ECU.

FIG. 3 is a functional block diagram of an ECU relating to vehicle control processing.

FIG. 4 is a view showing one example of the configuration of a classifier utilizing a DNN.

FIG. 5 shows one example of an input image.

FIG. 6 is a view, similar to FIG. 5, showing one example of an input image.

FIGS. 7A to 7C are views schematically showing two objects (vehicles) shown in an image and bounding boxes circumscribing these objects.

FIG. 8 is a flow chart showing object detection processing and vehicle control processing.

### DESCRIPTION OF EMBODIMENTS

Below, referring to the drawings, an object detection device, object detection method, and computer program for detecting object, according to an embodiment, will be explained. Note that, in the following explanation, similar component elements are assigned the same reference notations.

<Vehicle Control System>

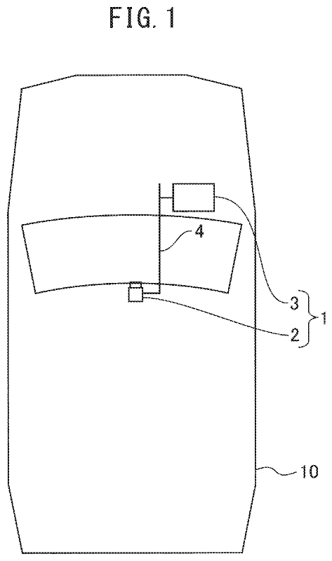

FIG. 1 is a view schematically showing the configuration of a vehicle control system in which an object detection device according to the present embodiment is mounted. The vehicle control system 1 is mounted in the vehicle 10 and operates the vehicle 10. In the present embodiment, the vehicle control system 1 performs an autonomous drive of the vehicle.

The vehicle control system 1 includes a camera 2, and electronic control unit (ECU) 3. The camera 2 and ECU 3 are connected so as to be able to communicate with each other through a vehicle internal network 4 based on the CAN (Controller Area Network) or other standards.

The camera 2 captures a predetermined range around the vehicle and generates an image of that range. The camera 2 includes a lens and imaging element and is, for example, a CMOS (complementary metal oxide semiconductor) camera or CCD (charge coupled device) camera.

In the present embodiment, the camera 2 is provided at the vehicle 10 and captures the surroundings of the vehicle 10. Specifically, the vehicle-mounted camera 2 is provided at the inside of the vehicle 10 and captures the region in front of the vehicle 10. For example, the vehicle-mounted camera 2 is provided on the back side of an inner rear-view mirror of the vehicle 10. The camera 2 captures the region in front of the vehicle 10 and generates an image of the front region, at every predetermined imaging interval (for example 1/30 see to 1/10 sec) while the ignition switch of the vehicle 10 is on. The image generated by the camera 2 is sent from the camera 2 through the vehicle internal network 4 to the ECU 3. The image generated by the camera 2 may be a color image or may be a gray image.

The ECU 3 functions as an object detection device performing an object detection processing for detecting an object shown in the image generated by the camera 2, and, in the present embodiment, controls the vehicle 10 so that the vehicle 10 is autonomously driven based on the detected object.

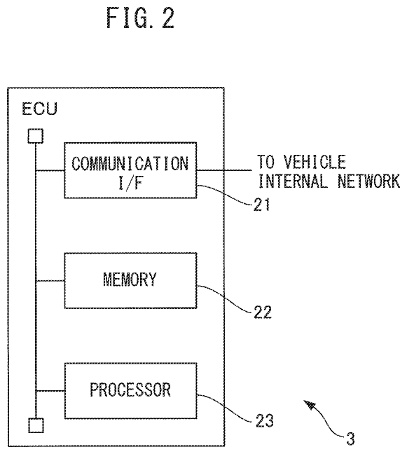

FIG. 2 is a view of the hardware configuration of the ECU 3. The ECU 3 has a communication interface 21, memory 22, and processor 23. The communication interface 21 and memory 22 are connected through signal lines to the processor 23.

The communication interface 21 has an interface circuit for connecting the ECU 3 to the vehicle internal network 4. That is, the communication interface 21 is connected through the vehicle internal network 4 to the camera 2. Further, the communication interface 21 receives an image from the camera 2 and sends the received image to the processor 23.

The memory 22, for example, has a volatile semiconductor memory and nonvolatile semiconductor memory. The memory 22 stores various types of data used when the various types of processing are performed by the processor 23. For example, the memory 22 stores an image received from the camera 2, map information, etc. Further, the memory 22 stores a computer program for performing the various types of processing by the processor 23.

The processor 23 has one or more CPUs (central processing units) and their peripheral circuits. The processor 23 may further have a GPU (graphics processing unit). The processor 23 performs the vehicle control processing including the object detection processing each time receiving the image from the camera 2, while the ignition switch of the vehicle 10 is on. Further, the processor 23 controls the vehicle 10 so that the vehicle 10 is autonomously driven, based on the detected object around the vehicle 10. Note that, the processor 23 may further have other processing circuits such as logic processing units or numeric processing units.

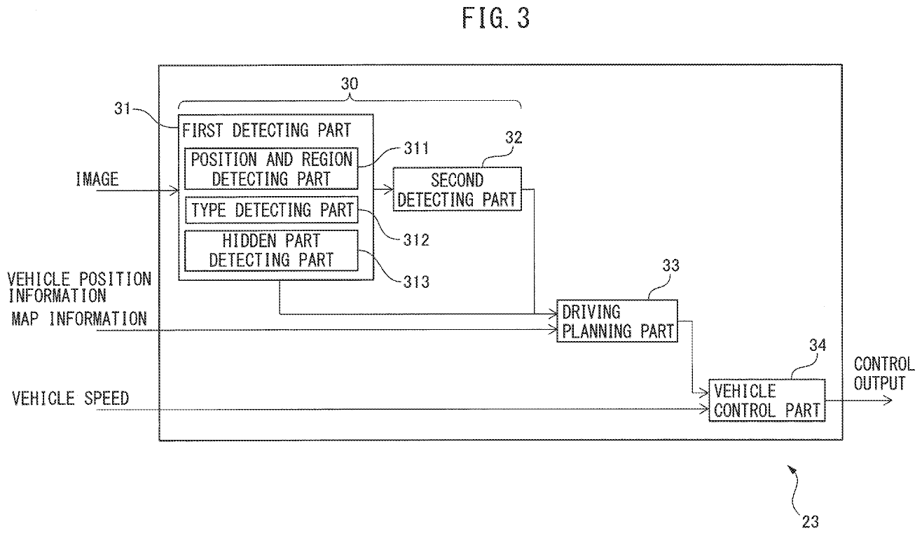

FIG. 3 is a functional block diagram of the ECU 3 relating to the vehicle control processing. The ECU 3 has an object detection part 30 performing the object detection processing, driving planning part 33, and vehicle control part 34. These functional blocks of the ECU 3 are, for example, functional modules realized by a computer program operating on the processor 23. Note that, these functional blocks may also be dedicated processing circuits provided at the processor 23.

<Object Detection Processing>

The object detection processing is performed by the first detecting part 31 and the second detecting part 32 among the functional blocks of the ECU 3. In the object detection processing, the position and/or size of an object shown in the image acquired from the camera 2 is detected. In particular, in the present embodiment, even when the part of the outer shape of an object in question shown in the image is hidden by another object shown in this image, the position and/or size of that object in question is detected.

The first detecting part 31 is provided with a position and region detecting part 311 detecting positions and regions of the objects shown in an image acquired from the camera 2, a type detecting part 312 detecting the types of the objects shown in the image acquired from the camera 2, and a hidden part detecting part 313 detecting if parts of outer shapes of the objects shown in an image acquired from the camera 2 are hidden by other objects shown in the image.

In the present embodiment, the position and region detecting part 311, type detecting part 312, and hidden part detecting part 313 of the first detecting part 31 are configured as classifiers using neural networks (below, also referred to as “NNs”). In particular, in the present embodiment, as the neural networks, deep neural networks (below, also referred to as “DNNs”) each having a plurality of intermediate layers between an input layer and an output layer are utilized.

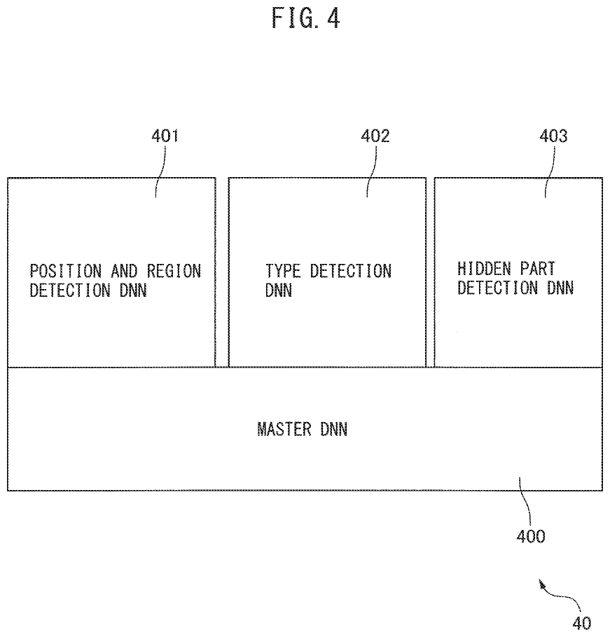

FIG. 4 is a view showing one example of the configuration of a classifier 40 utilizing a DNN used in the first detecting part 31. As shown in FIG. 4, the classifier 40 has a master DNN 400, position and region detection DNN 401, type detection DNN 402, and hidden part detection DNN 403.

The master DNN 400 receives as input an image captured by the camera 2. The position and region detection DNN 401, type detection DNN 402, and hidden part detection DNN 403 are all connected in series to the master DNN 400 at the downstream side (output side) from the master DNN 400.

The master DNN 400 is a base network having an input layer to which an image captured by the camera 2 is input. The master DNN 400, for example, is configured as a convolutional neural network (CNN) having a plurality of convolutional layers connected in series from an input side to an output side. In this case, the master DNN 400 may be provided with a pooling layer provided for every one or more convolutional layers. Further, the master DNN 400 may have one or more fully connected layers. Specifically, the master DNN 400, for example, has a configuration similar to the VGG16, which is the base network of the Single Shot MultiBox Detector (SSD) described in NPL 1. Alternatively, the master DNN 400 may have a configuration similar to a ResNet (Residual Network), AlexNet, or other CNN architecture.

If an image is input, the master DNN 400 performs the processing at the different layers on that image to thereby calculate a feature map from that image and outputs the same. The position and region detection DNN 401, type detection DNN 402, and hidden part detection DNN 403 respectively receive as input the feature map output from the master DNN 400.

The position and region detection DNN 401, type detection DNN 402, and hidden part detection DNN 403, for example, are configured as convolutional neural networks (CNN) each having a plurality of convolutional layers connected in series from an input side to an output side. In this case, the position and region detection DNN 401, type detection DNN 402, and hidden part detection DNN 403 may be provided with pooling layers provided for every one or more convolutional layers. Further, the position and region detection DNN 401, type detection DNN 402, and hidden part detection DNN 403 may have one or more fully connected layers.

The position and region detection DNN 401 has an output layer outputting the positions and regions of the objects in an image. In the present embodiment, the output layer of the position and region detection DNN 401 outputs bounding boxes of rectangular shapes circumscribing objects to thereby show the positions and regions of the objects. Specifically, the output layer of the position and region detection DNN 401, for example, outputs center coordinates (x, y), widths “w”, and heights “h” of the bounding boxes. Alternatively, the output layer of the position and region detection DNN 401, for example, may output the top left vertex coordinates (x, y), widths “w”, and heights “h” of the bounding boxes or may output the top left vertex coordinates (x, y) of the bounding boxes and the bottom right vertex coordinates (x, y) of the bounding boxes. If the above-mentioned SSD is used for detection of the positions and regions or detection of the types of objects, the output layer of the position and region detection DNN 401 outputs the differences from regions of various positions, various sizes, and various aspect ratios on the image (default boxes). At the output layer of the position and region detection DNN 401, as the activation function, for example, an identity function is used.

Note that, the position and region detection DNN 401 outputs rectangular bounding boxes circumscribing the objects. However, the position and region detection DNN 401 may also show the positions and regions of the objects by shapes other than rectangles, so long as they are shapes circumscribing the objects. Specifically, the position and region detection DNN 401, for example, may show positions and regions of the objects by circular, pentagonal, or other polygonal shapes.

The type detection DNN 402 has an output layer outputting the types of the objects shown in an image. For example, the type detection DNN 402 has an output layer outputting the confidence levels of the types of objects being detected, for each of the regions of the various positions, various sizes, and various aspect ratios on the image. Specifically, the type detection DNN 402 outputs the confidence levels of a large number of types of objects prepared in advance (for example, passenger cars, buses, motorcycles, signs, traffic lights, etc.). Therefore, if a passenger car is shown in a region in question, a high value is output from a node showing the confidence level of a passenger car and a low value is output from a node showing the confidence level of another object. In the type detection DNN 402, for example a softmax function is used as the activation function.

The hidden part detection DNN 403 has an output layer outputting whether predetermined parts of outer shapes of objects shown in an image are hidden by other objects. For example, the hidden part detection DNN 403 has an output layer outputting whether objects included in regions are hidden by other objects, for each of the regions of the various positions, various sizes, and various aspect ratios on the image.

Specifically, the hidden part detection DNN 403 outputs whether an overall side of bounding box circumscribing an object are positioned inside bounding boxes circumscribing other objects or on outer lines of the bounding boxes. If one side as a whole of a bounding box circumscribing a certain object is positioned inside a bounding box circumscribing another object or on the outer lines of the bounding box circumscribing another object, it is deemed that a predetermined part of that certain object is hidden by the other object.

Alternatively, the hidden part detection DNN 403 outputs whether an overall side of a bounding box circumscribing an object is completely contained in regions in the image of other objects. If one side as a whole of a bounding box circumscribing a certain object is completely contained in a region in an image of another object, it is deemed that a predetermined part of that certain object is hidden by the other object.

The hidden part detection DNN 403 may also output the confidence level as to whether parts of objects are hidden by other objects as a numerical value of 0 to 1 (hiding confidence level). If the hiding confidence level is small, it shows the possibility is high of that part not being hidden, while if the hiding confidence level is large, it shows the possibility is high of that part being hidden. In this case, the hidden part detecting part 313 judges that the part is hidden if the hiding confidence level is equal to or greater than a certain threshold value and judges that the part is not hidden if it is less than this threshold value.

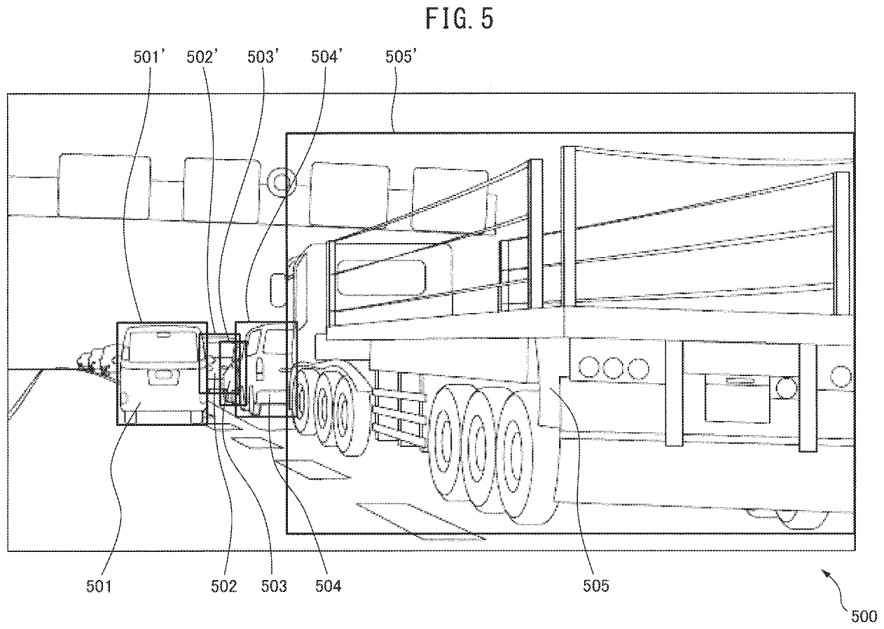

FIG. 5 shows one example of an image which is input. FIG. 5 shows the state where a large number of vehicles, which are objects shown in an image 500, are surrounded by bounding boxes. The image 500 of FIG. 5 shows five vehicles (objects) 501 to 505. Among these, the first vehicle 501 and the fifth vehicle 505 are shown on the image 500 without being hidden by other vehicles. Therefore, the first bounding box 501′ circumscribing the first vehicle 501 surrounds the first vehicle 501 as a whole. Accordingly, it is possible to accurately estimate the position or size of the first vehicle 501 from the width “w” or the height “h” of the first bounding box. The same is true for the fifth bounding box 505′ circumscribing the fifth vehicle 505.

On the other hand, the second vehicle 502 has its left side hidden by the first vehicle 501 and its right side hidden by the third vehicle 503. Therefore, the second bounding box 502′ circumscribing the second vehicle 502 does not surround the second vehicle 502 as a whole. Accordingly, it is difficult to accurately estimate the position or size of the second vehicle 502 from the width “w” or the height “h” of the second bounding box. Further, the third vehicle 503 and the fourth vehicle 504 have right sides hidden by the fourth vehicle 504 and the fifth vehicle, respectively. Therefore, it is difficult to accurately estimate the positions or sizes of the third vehicle 503 and the fourth vehicle 504 from the third bounding box 503′ and the fourth bounding box 504′.

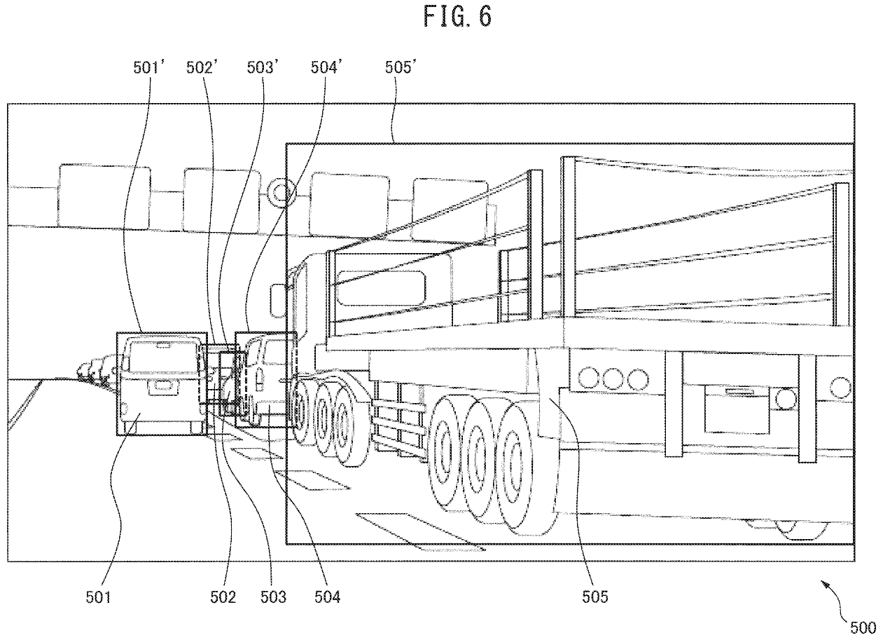

FIG. 6 is a view showing one example of an input image similar to FIG. 5. In FIG. 6, by the hidden part detection DNN 403, the sides, among the sides forming the bounding boxes circumscribing the objects, which are positioned inside the bounding boxes circumscribing other objects or on the outer lines of these bounding boxes, are shown by broken lines.

The left side as a whole of the second bounding box 502′ circumscribing the second vehicle 502 is positioned inside the first bounding box 501′ circumscribing the first vehicle 501. For this reason, the hidden part detection DNN 403 judges that the left side as a whole of the second bounding box 502′ circumscribing the second vehicle 502 is positioned inside the bounding box circumscribing another object. In other words, the hidden part detection DNN 403 judges that part of the left side of the second vehicle is hidden by another object. The hidden part detection DNN 403 judges that part of the right side of the second vehicle 502, part of the right side of the third vehicle 503, and part of the right side of the fourth vehicle are similarly hidden by another object.

Note that, as explained above, instead of rectangular shaped bounding boxes, the positions and regions of objects may also be shown by shapes other than rectangular shapes. In this case, the hidden part detection DNN 403 judges that the predetermined part of the outer shape of the object in question is hidden by another object shown in the image if, when dividing the outer lines of a shape circumscribing an object in question shown in the image into a plurality of portions, one divided portion as a whole is positioned inside the shape circumscribing another object or on the outer lines of that shape. For example, if the positions and regions of objects are shown by polygonal shapes, the hidden part detection DNN 403 judges that a predetermined part of an outer shape of an object in question is hidden by another object shown in the image when the sides as a whole are positioned within a polygonal shape circumscribing the other object.

The position and region detecting part 311 of the first detecting part 31 is configured by a DNN including a master DNN 400 and a position and region detection DNN 401. Further, the type detecting part 312 of the first detecting part 31 is configured by a master DNN 400 and a type detection DNN 402. In addition, the hidden part detecting part 313 of the first detecting part 31 is configured by the master DNN 400 and hidden part detection DNN 403. The DNNs forming the position and region detecting part 311, type detecting part 312, and hidden part detecting part 313 may be configured in the same way as an SSD, Faster R-CNN, You Only Look Once (YOLO), etc. so that the precision of detection of objects is higher and the speed of detection of objects is faster.

The DNNs forming the position and region detecting part 311, type detecting part 312, and hidden part detecting part 313 are raised in precision of detection by learning. In the learning, images with the true data or a true label are used as teacher data. True data includes the positions and regions of objects in the images, while true labels include data as to the types of the objects and whether parts in the objects are hidden by other objects. As the teacher data indicating whether parts in the objects are hidden by other parts, for example, a 0/1 label is attached to each part in each object in which 0 is attached when a part is not hidden by another object and 1 is attached when it is hidden by another object, by an annotation worker visually examining an image or an automatic annotation tool to which an image for learning is input.

The learning of the DNNs forming the position and region detecting part 311, type detecting part 312, and hidden part detecting part 313 is performed using a large number of teacher data by the error back propagation method or other learning method. In the error back propagation method, the weights at the DNNs are repeatedly updated so that the outputs of the DNNs become closer to the true data or true labels, that is, therefore that the values of the loss functions become smaller. For example, as the loss function of the hidden part detecting part 313, cross entropy between the 0/1 teacher data label indicating whether parts of the objects are hidden by other objects and hiding confidence levels output by the hidden part detection DNN 403 is used.

Therefore, the position and region detecting part 311 of the first detecting part 31 detects the positions and regions of objects, if an image is input into a neural network which is learned in advance so as to output positions and regions of objects when an image is input. Further, the type detecting part 312 of the first detecting part 31 detects the types of the objects, if an image is input into a neural network which is learned in advance so as to output types of objects when an image is input. Furthermore, the hidden part detecting part 313 of the first detecting part 31 detects if a predetermined part of the outer shape of the object in question is hidden by another object, if an image is input into a neural network which is learned in advance so as to output a part of an outer shape of an object in question which is hidden by another object when an image is input.

When the first detecting part 31 detects that a predetermined part of the outer shape of an object in question is hidden, the second detecting part 32 detects the position and/or size of the object in question based on the position of the part of the outer shape of the object in question hidden by another object. In particular, in the present embodiment, the second detecting part estimates the outer shape of the object in question when assuming the object in question as a whole is not hidden, based on the position of the part of the object in question which is hidden, and detects the position and/or size of the object in question based on the estimated outer shape.

Specifically, the second detecting part 32 estimates the outer shape of the object in question when assuming that the object in question as a whole is not hidden, based on the position of the part of the object in question which is hidden, by using a past image which was acquired before the current image and in which the outer shape of the object in question was not hidden by another object to.

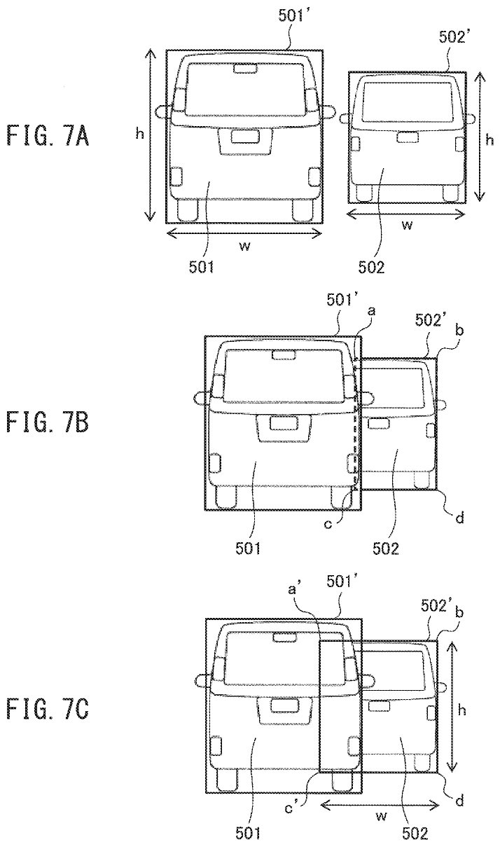

FIGS. 7A to 7C are views schematically showing two objects (vehicles) shown in an image and bounding boxes circumscribing these objects. FIG. 7A shows the state where the vehicles are not hidden by other vehicles. Therefore, in the state shown in FIG. 7A, the hidden part detecting part 313 of the first detecting part 31 judges that predetermined parts of the outer shapes of the first vehicle 501 and the second vehicle 502 are not hidden by other objects. At this time, the relationships of the widths “w” and heights “h” of the bounding boxes 501′ and 502′ circumscribing the vehicles 501, 502 are calculated.

FIG. 7B shows the state where, after the state shown in FIG. 7A, the relative positions with other vehicles change and thus part of the second vehicle 502 is hidden by the first vehicle 501. Therefore, in the state shown in FIG. 7B, at the hidden part detecting part 313 of the first detecting part 31, it is judged that a predetermined part of the outer shape of the first vehicle 501 is not hidden by another object, but it is judged that part of the outer shape of the second vehicle 502 is hidden by another object.

In particular, in the state shown in FIG. 7B, the first detecting part 31 judges that the entire left side of the bounding box 502′ circumscribing the second vehicle 502 is positioned inside the bounding box 501′ circumscribing the first vehicle 501 (other object). Therefore, the vertices “a” and “c” positioned at the top and bottom of the left side of the bounding box 502′ cannot be used for estimating the position or size of the second vehicle 502. On the other hand, it is judged that the entire right side of the bounding box 502′ circumscribing the second vehicle 502 is not positioned inside or on the bounding box 501′ circumscribing the first vehicle 501 (other object). Therefore, the vertices “b” and “d” positioned at the top and bottom of the right side of the bounding box 502′ can be used for estimating the position or size of the second vehicle 502.

Therefore, in the present embodiment, the second detecting part 32 calculates the height “h” of the second vehicle 502 from the vertices “b” and “d” positioned at the top and bottom of the right side of the second vehicle 502 which is a part of the second vehicle 502 which is not hidden. In addition, the second detecting part 32 calculates the relationship between the width “w” and height “h” of the second vehicle 502 based on a past image which was acquired before the current image shown in FIG. 7B and in which the outer shape of the second vehicle 502 was not hidden by another object (image such as shown in FIG. 7A). The positions of the vertices “a” and “c” positioned at the top and bottom of the left side of the second vehicle 502 are corrected based on the relationship of the width “w” and height “h” of the second vehicle 502 calculated in this way and the height “h” of the bounding box 502′ circumscribing the second vehicle 502 shown in FIG. 7B. FIG. 7C shows the corrected bounding box 502″ showing the second vehicle 502 using the vertices a′ and c′ which are corrected from the vertices “a” and “c” positioned at the top and bottom of the left side of the second vehicle 502. As a result, the second detecting part 32 can suitably estimate the position and size of the bounding box 502″ showing the second vehicle 502 regardless of a part of the second vehicle 502 being hidden by the first vehicle 501. In other words, the second detecting part 32 can suitably estimate the outer shape of the second vehicle 502 when it is assumed the second vehicle 50 as a whole is not hidden, although part of the second vehicle 502 is hidden by the first vehicle 501. Therefore, according to the present embodiment, the position or size of an object in question shown in an image is kept from being mistakenly recognized. Further, the position and/or size of the object in question is detected, based on the position and size of the bounding box 502″ estimated in this way, that is, based on the estimated outer shape of the second vehicle.

Note that, in the present embodiment, the second detecting part 32 uses a past image to estimate the outer shape of an object in question, when assuming the object in question as a whole is not hidden. However, the second detecting part 32 may also estimate the outer shape of the object in question based on data other than a past image. For example, it is also possible to store currently image data of a large number of existing vehicles in the memory 22, compare images of the parts of objects not hidden and that image data to identify the types of the objects (for example, vehicle models), and estimate the outer shapes of the objects based on the types of the objects. In this case, for example, the memory 22 stores the relationship of the width “w” and height “h” for each vehicle model. If the vehicle model is identified from the parts of the vehicles not hidden, it is possible to find the relationship between the height “h” and the width “w” of the vehicle and thereby correct the positions of the two vertices of the hidden side based on this relationship.

Further, the second detecting part 32 of the present embodiment estimates the outer shape of the object in question, then the position and/or size of the object in question is detected based on the estimated outer shape. However, the second detecting part 32 may also not estimate the outer shape of the object in question but may directly detect the position and/or size of the object in question based on the position of part of the outer shape of the object in question hidden by another object. In this case, the position and/or size of the object in question is, for example, detected by inputting an image into a neural network, which is learned in advance so that when an image within a bounding box circumscribing a partially hidden object is input, it outputs the position and/or size of the object.

<Vehicle Control Processing>

The vehicle control processing is performed by the driving planning part 33 and vehicle control part 34 among the functional blocks of the ECU 3. In the vehicle control processing, the operation of the vehicle 10 is controlled, based on the positions and sizes of the objects shown in the images detected by the object detecting part 30, so that objects present around the vehicle 10 and the vehicle 10 do not collide.

The driving planning part 33 refers to the positions or sizes of the objects found in each image and generates one or more scheduled driving paths of the vehicle 10 so that objects present around the vehicle 10 and the vehicle 10 will not collide. A scheduled driving path is, for example, expressed as a set of target positions of the vehicle 10 at different times from the current time to a predetermined time in the future. For example, the driving planning part 33 performs tracking processing using a Kalman filter, etc., on a series of images each time receiving an image from the camera 2 so as to track the objects shown in the images, and estimate the predicted paths to a predetermined time in the future for the respective objects, based on the paths obtained by the results of tracking.

The driving planning part 33 generates the scheduled driving path of the vehicle 10, based on the predicted paths of the objects being tracked, so that the predicted values of the distances between the objects being tracked and the vehicle 10 up to a predetermined time in the future is equal to or greater than predetermined values for all of the objects. At this time, the driving planning part 33 may, for example, refer to the current position information of the vehicle 10 obtained from a GPS receiver (not shown) mounted in the vehicle 10 and the map information stored in the memory 22 so as to confirm the number of lanes in which the vehicle 10 can drive. Then, if there are a plurality of lanes in which the vehicle 10 can drive, the driving planning part 33 may generate a scheduled driving path changing the lanes in which the vehicle 10 can drive so that the distance between each of the objects being tracked and the vehicle 10 is equal to or greater than a predetermined distance. The driving planning part 33 notifies the generated scheduled driving path to the vehicle control part 34.

Note that, the driving planning part 33 may also generate a plurality of scheduled driving paths. In this case, the driving planning part 33 may select the path, among the plurality of scheduled driving paths, which gives the smallest total sum of the absolute values of the acceleration degrees of the vehicle 10.

The vehicle control part 34 controls the parts of the vehicle 10 so that the vehicle 10 drives along the notified scheduled driving path. For example, the vehicle control part 34 calculates the acceleration degree of the vehicle 10 in accordance with the notified scheduled driving path and the current vehicle speed of the vehicle 10 measured by a vehicle speed sensor (not shown). Next, the vehicle control part 34 sets the accelerator opening degree or braking amount so as to give that acceleration degree. Further, the vehicle control part 34 outputs a control signal to the internal combustion engine or motor used as the drive device of the vehicle 10 so that a drive force corresponding to the set accelerator opening degree is generated. Alternatively, the vehicle control part 34 outputs a control signal corresponding to the amount of braking set, to the brakes of the vehicle 10.

Furthermore, when changing the advancing path of the vehicle 10 so that the vehicle 10 drives along the scheduled driving path, the vehicle control part 34 finds the steering angle of the vehicle 10 in accordance with that scheduled driving path, and outputs a control signal corresponding to that steering angle to an actuator (not shown) controlling the steering wheel of the vehicle 10.

<Specific Processing>

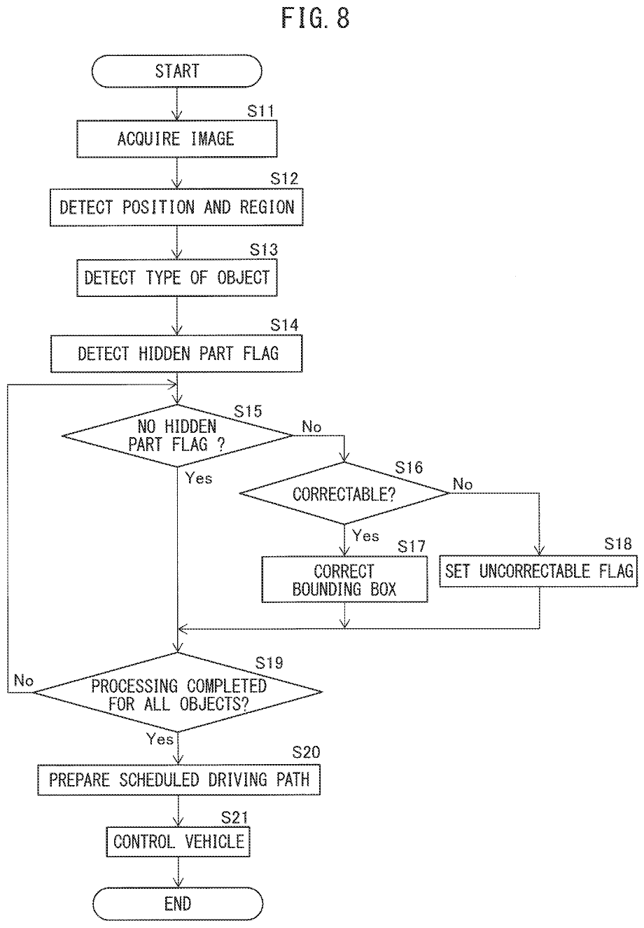

Next, referring to FIG. 8, object detection processing and vehicle control processing will be explained. FIG. 8 is a flow chart showing object detection processing and vehicle control processing. The object detection processing and vehicle control processing shown in FIG. 8 are repeatedly performed by the processor 23 of the ECU 3 at predetermined intervals. The predetermined intervals are, for example, intervals at which images are sent from the camera 2 to the ECU 3. Note that, in the flow chart shown in FIG. 8, at steps S11 to S19, object detection processing is performed, while at steps S20 to S21, vehicle control processing is performed.

First, at step S11, the first detecting part 31 acquires an image from the camera 2. The acquired image is input to the position and region detecting part 311, type detecting part 312, and hidden part detecting part 313 of the first detecting part 31.

At step S12, the position and region detecting part 311 detects the positions and regions of objects shown in an image, by using the master DNN 400 and the position and region detection DNN 401. Specifically, the position and region detecting part 311 inputs an image to the master DNN 400 and outputs the positions and regions of the objects from the position and region detection DNN 401.

Next, at step S13, the type detecting part 312 detects the types of objects shown in an image, by using the master DNN 400 and the type detection DNN 402. Specifically, the type detecting part 312 inputs an image to the master DNN 400 and outputs, from the type detection DNN 402, the confidence levels of the types of the objects for each region of various positions, various sizes and various aspect ratios on an image.

Next, at step S14, the hidden part detecting part 313 detects if predetermined parts in the outer shapes of objects shown in an image are hidden by other objects, by using the master DNN 400 and hidden part detection DNN 403. Specifically, the hidden part detecting part 313 inputs an image to the master DNN 400 and outputs from the hidden part detection DNN 403 whether a predetermined part of the outer shape of an object included in a region is hidden by another object for each region of various positions on an image and various sizes and various aspect ratios.

In particular, in the present embodiment, the hidden part detecting part 313 outputs a right side hidden part flag if the entire right side of a bounding box circumscribing each object shown in the image is positioned inside a bounding box circumscribing another object or on outer lines of this bounding box. Similarly, the hidden part detecting part 313 respectively outputs a left side hidden part flag, top side hidden part flag, and bottom side hidden part flag if the entire left side, entire top side, and entire bottom side are positioned inside or on a bounding box circumscribing another object. On the other hand, the hidden part detecting part 313 does not output any hidden part flag if none of the sides of the bounding boxes circumscribing the objects shown in the image are positioned inside or on a bounding box circumscribing another object.

At step S15, the second detecting part 32 judges if a hidden part flag has been output at step S14 for any single object in question shown in the image acquired at step S11. If at step S14 it is judged that a hidden part flag has not been output for the object in question, the control flow proceeds to step S19. On the other hand, if at step S15 it is judged that a hidden part flag is output for the object in question, the control flow proceeds to step S16.

At step S16, it is judged if the second detecting part 32 can correct the bounding box circumscribing an object in question for which a hidden part flag has been output. For example, if hidden part flags arc output for the three sides of the bounding box circumscribing a certain object, there are no longer lines or sides serving as the reference when correcting the bounding box, therefore it is judged that correcting the bounding box is impossible. Further, for example, if using a past image of the object in question for correction, it is judged that the bounding box of the object in question cannot be corrected, when there is no past image of the object in question. If at step S16 it is judged that the bounding box can be corrected, the control flow proceeds to step S17.

At step S17, the second detecting part 32 corrects the bounding box circumscribing the object in question in which the hidden part flag is output. The bounding box is corrected, for example, based on the type of the output hidden part flag (that is, which hidden part flag, among a right side hidden part flag, left side hidden part flag, top side hidden part flag, and bottom side hidden part flag, is output), and the relationship between the width “w” and height “h” of the object in question in past images. That is, the bounding box is corrected, based on the position of part of the outer shape of the object in question hidden by another object, and a relationship between a width “w” and height “h” of an object in question in a past image.

On the other hand, if at step S16 it is judged that the bounding box cannot be corrected, the control flow proceeds to step S18. At step S18, an uncorrectable flag is set for the object in question. The uncorrectable flag is considered when preparing the scheduled driving path at step S20.

At step S19, it is judged if the processing of steps S15 to S18 was performed for all of the objects shown in the image acquired at step S11. If there are remaining objects, the processing of steps S15 to S18 is repeated. On the other hand, if at step S19 it is judged that the processing has been performed for all of the objects, the control flow proceeds to step S20.

At step S20, the driving planning part 33 estimates the predicted paths of objects shown in the images, based on the bounding boxes of the objects detected at step S12 and the bounding boxes of the objects corrected at step S17. After that, the driving planning part 33 generates a scheduled driving path of the vehicle 10, based on the predicted paths of the objects, so that the distances between the objects and vehicle 10 are equal to or greater than predetermined distances.

Next, at step S21, the vehicle control part 34 controls the vehicle 10 so that the vehicle 10 drives along the scheduled driving path. Specifically, the vehicle control part 34 operates the various types of actuators of the vehicle 10 (throttle valve, motor, steering system, brake actuator, etc.) to control the acceleration, steering, and braking of the vehicle 10.

Note that, a computer program realizing the functions of the various functional blocks of the ECU 3 may also be provided in a form recorded in a semiconductor memory, magnetic recording medium, optical recording medium, or other such computer readable portable recording medium.

Further, the object detection device according to the above embodiment may also be mounted at other than a vehicle. For example, the object detection device may also be configured to be mounted at a server, etc., so as to detect an object from an image generated by a monitoring camera installed inside a building or outside a building or a camera mounted in a drone.

### REFERENCE SIGNS LIST

1. vehicle control system
2. camera
3. electronic control unit (ECU)
10. vehicle
30. object detecting part
31. first detecting part
311. position and region detecting part
312. type detecting part
313. hidden part detecting part
32. second detecting part
33. driving planning part
34. vehicle control part

1. An object detection device, configured to:
detect from an acquired image whether a predetermined part of an outer shape of an object in question shown in that image is hidden by another object shown in that image; and
detect a position and/or size of the object in question based on a position of the part of the outer shape of the object in question hidden by the other object, when it is detected that the predetermined part of the outer shape of the object in question is hidden.

2. The object detection device according to claim 1, configured to estimate the outer shape of the object in question when assuming that the object in question as a whole is not hidden, based on the position of the hidden part, and detect the position and/or size of the object in question based on that estimated outer shape.

3. The object detection device according to claim 2 configured to estimate the outer shape of the object in question at a time assuming that the object in question as a whole is not hidden, based on the position of the hidden part, by using a past image which was acquired before that image and in which the outer shape of the object in question was not hidden by another object.

4. The object detection device according to claim 1, wherein when dividing the outer lines of a shape circumscribing the object in question shown in the image into a plurality of portions, the object detection device is configured to judge that the predetermined part of the outer shape of the object in question is hidden by another object shown in the image, if one divided portion as a whole is positioned inside a shape circumscribing the other object or on the outer lines of that shape.

5. The object detection device according to claim 1, configured to input the image in a neural network which is learned in advance so as to output whether the predetermined part of the outer shape of the object in question is hidden by another object shown in the image when the image is input, and detect if the predetermined part of the outer shape of the object in question is hidden by another object.

6. An object detection method, comprising:
detecting, from an acquired image, whether a predetermined part of an outer shape of an object in question shown in that image is hidden by another object shown in that image; and
detecting a position and/or size of the object in question based on a position of the part of the outer shape of the object in question hidden by the other object when it is detected that the predetermined part of the outer shape of the object in question is hidden.

7. A computer program for detecting object, making a computer:
detect, from an acquired image, whether a predetermined part of an outer shape of an object in question shown in that image is hidden by another object shown in that image; and
detect a position and/or size of the object in question, based on a position of the part of the outer shape of the object in question hidden by the other object, when it is detected that the predetermined part of the outer shape of the object in question is hidden.
